(19) United States
(12) Patent Application Publication
(10) Pub. No.: US 2025/0288899 A1
(43) Pub. Date: Sep. 18, 2025

(54) GAME DEVICE AND LOTTERY GAME DEVICE

(71) Applicant: SEGA CORPORATION, Tokyo (JP)

(72) Inventors: Yuto Sugita, Tokyo (JP); Satoshi Doi, Tokyo (JP); Yotaro Sakurai, Tokyo (JP)

(73) Assignee: SEGA CORPORATION, Tokyo (JP)

(21) Appl. No.: 19/226,928

(22) Filed: Jun. 3, 2025

Related U.S. Application Data
(63) Continuation of application No. PCT/JP2023/038106, filed on Oct. 20, 2023.

(30) Foreign Application Priority Data
Dec. 15, 2022 (JP) 2022-200480

(51) Int. Cl. A63F 5/02

(52) U.S. Cl. CPC A63F 5/02

(57) ABSTRACT

A game device includes: a play board that includes a base and guide pins disposed on the base in rows along a predetermined direction of the base, a play medium hitting and rebounding from at least one of the guide pins to change a movement direction; a medium reception unit that is disposed on the base and configured to receive the play medium rebounded from the at least one of guide pins; and a medium throwing unit that throws the play medium toward the guide pins such that the play medium reaches the medium reception unit. The guide pins are configured to meet at least one of conditions that: at least one of the guide pins has elasticity different from elasticity of another of the guide pins; and at least one inter-row distance between the rows is different from another inter-row distance.

### BACKGROUND

### Technical Field

The present invention relates to a game device and a lottery game device.

### Description of Related Art

Conventionally, a lottery game device in which a falling ball's trajectory is changed by using a plurality of pins is known (see, for example, Patent Document 1).

### PATENT DOCUMENT

Patent Document 1: JP 2000-350803 A

### Technological Problem to be Solved by Invention

In the conventional lottery game device disclosed in Patent Document 1, because each of the plurality of pins has the same configuration, the elastic force received by the ball (play medium) when it passes through those pins is the same. Therefore, the ball bounces in a uniform manner and falls at a high speed. As a result, the duration of the lottery game will be shortened, which may affect a player's anticipation for the lottery game and the amusement for the lottery game itself.

SUMMARY

One or more embodiments of the present invention provide a game device and a lottery game device that can increase a player's anticipation for the lottery and the amusement for the lottery game by using a simple configuration to change the falling aspect of a play medium such as a ball in a Corinth game or the like, thereby extending the time during which the movement of the play medium is highly amusing.

According to one aspect of the present invention, a game device comprises a play board that comprises: a base; and guide pins disposed on the base in rows along a predetermined direction of the base, wherein a play medium may hit and rebound from at least one of the guide pins to change a movement direction; a medium reception unit that is disposed on the base and configured to receive the play medium rebounded from the at least one of guide pins; and a medium throwing unit that throws the play medium toward the guide pins such that the play medium reaches the medium reception unit, wherein the guide pins are configured to meet at least one of conditions that: at least one of the guide pins has elasticity different from elasticity of another of the guide pins; and at least one inter-row distance between the rows is different from another inter-row distance.

By adopting such a configuration, it is possible to diversify the falling aspect in which the play medium in the Corinth game falls and extend the fall time by using a simple configuration.

In the game device according to one aspect of the present invention, the guide pins include: a first guide pin having a first elasticity; and a second guide pin having a second elasticity greater than the first elasticity, and the second guide pin may be positioned in a predetermined direction closer to a first end side of the base than some or all of the first guide pins.

By adopting such a configuration, the elasticity of the guide pin that comes into contact with the lottery unit relatively quickly is increased, and the elasticity of the guide pin that comes into contact with the lottery unit relatively late is decreased, thereby making it possible to make the range of movement of the play medium when it first falls narrower than the range of movement of the subsequent play medium.

In the game device according to one aspect of the present invention, among the rows, a first row closest to the medium throwing unit in the predetermined direction may be constituted by the first guide pin.

By adopting such a configuration, the player can easily insert a play medium into the row of guide pins that is being aimed at.

In the game device according to one aspect of the present invention, the medium throwing unit has a relationship with the play medium that: d<l≤2d, where d denotes a maximum diameter of the play medium, and l denotes a shortest distance between the medium throwing unit and the first row.

By adopting such a configuration, it is possible to prevent a play medium from bouncing immediately after being inserted from the insert part, and it is possible to more easily insert the play medium into the target row of guide pins.

In the game device according to one aspect of the present invention, among the rows, a number of rows defined by the second guide pin may be greater than a number of rows defined by the first guide pin.

By adopting such a configuration, the number of guide pins with high elasticity is made greater than the number of guide pins with low elasticity, such that the falling time of the play medium can be reliably extended.

In the game device according to one aspect of the present invention, among the inter-row distances each between the rows, at least one inter-row distance may be larger than another of the inter-row distances.

By adopting this type of configuration, the range over which the play medium can be bounced can be adjusted by adjusting the distance between the rows.

In the game device according to one aspect of the present invention, the at least one inter-row distance is closer to a first end side of the base than a second row disposed close to a second end of the base in the predetermined direction.

By adopting such a configuration, the bouncing range of the play medium can be increased by approaching the medium reception unit, the falling time of the play medium can be extended, and the player's anticipation of the game can be increased.

In the game device according to one aspect of the present invention, each of the guide pins is attached to the base via an attachment fixture, and the attachment fixture may be made of a material having a lower hardness than each of the guide pins and prevent each of the guide pins from directly contacting the base.

By adopting such a configuration, it is possible to absorb vibrations of the guide pin compared to attaching the guide pin directly to the base, and by using a material that is less hard than the material of the base, it is possible to reduce the risk of the attachment fixture vibrating and wearing down the base. As a result, the orientation and attaching precision of the guide pin relative to the base can be easily maintained.

According to one aspect of the present invention, a lottery game device comprises a first lottery game unit that executes a Corinth game and comprises the game device according to claim 1; a second lottery game unit that executes a Pusher game using a medal and a ball; a starting medium reception unit that receives a play starting medium thrown by a player's operation; a payout unit that pays out a play result medium to a player; and a controller configured to pay out the play result medium to the payout unit, wherein the play result medium corresponds to one of: a lottery result of the Corinth game started in response to the starting medium reception unit receiving the play starting medium; a medal lottery result of the Pusher game; and a lottery result of the Corinth game started based on a ball lottery result of the Pusher game.

By adopting such a configuration, the push game can be played at the same time as the Corinth game, making it possible to diversify the falling aspect of the play medium in the Corinth game and extend the falling time, and the correlation between the two games can increase players' anticipation for the lottery and amusement with respect to the lottery game.

According to one or more embodiments of the present invention, it is possible to provide a game device and a lottery game device that use a simple structure to change the falling aspect of the play medium used in the Corinth game, extending a time of high amusement with respect to the play medium movement, and improve the player's sense of anticipation for the lottery and amusement with respect to the play medium movement.

### BRIEF DESCRIPTION OF DRAWINGS

FIG. 1 is a perspective view illustrating a configuration of a lottery game device according to one or more embodiments of the present invention.

FIG. 2 is a schematic diagram illustrating a state in which the lottery game device according to one or more embodiments is used.

FIG. 3 is a perspective view illustrating a configuration of a lottery game device according to one or more embodiments of the present invention.

FIG. 4 is a diagram illustrating a configuration of a front side of a first lottery game unit of the lottery game device according to one or more embodiments.

FIG. 5 is a diagram illustrating a configuration of a back side of a first lottery game unit of the lottery game device according to one or more embodiments.

FIG. 6 is a cross-sectional diagram illustrating a configuration of an attachment part of the first lottery game unit of the lottery game device according to one or more embodiments.

FIG. 7 is a diagram illustrating a configuration of a second lottery game unit of the lottery game device according to one or more embodiments.

FIG. 8 is a diagram illustrating a conveyor part of a second lottery game unit of the lottery game device according to one or more embodiments.

FIG. 9 is a diagram illustrating a top end portion of the conveyor part of a second lottery game unit of the lottery game device according to one or more embodiments.

FIG. 10 is a flowchart illustrating control of the lottery game by a control unit of the lottery game device according to one or more embodiments.

### DETAILED DESCRIPTION OF EMBODIMENTS

Hereinafter, embodiments of the present invention will be described with reference to the respective drawings. In addition, unless otherwise specified, the positional relationships such as up, down, left, and right in the drawings are based on the positional relationships illustrated in the drawings. Furthermore, the dimensional ratios of the drawings are not limited to those illustrated in the drawings. Furthermore, the following embodiments are examples for explaining the present invention, and are not intended to limit the present invention to only these embodiments. Furthermore, the present invention can be modified in various ways without departing from the spirit and scope of the invention.

### <Overview of Lottery Game Device 1>

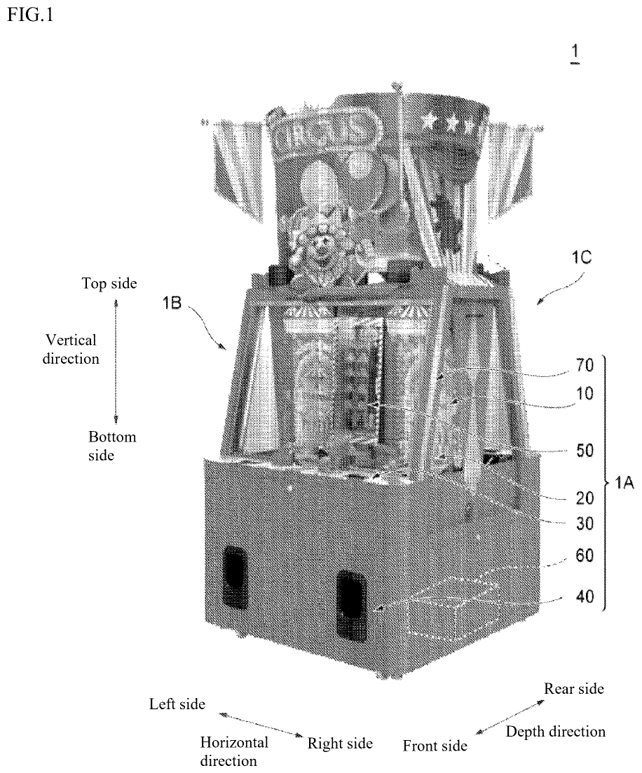

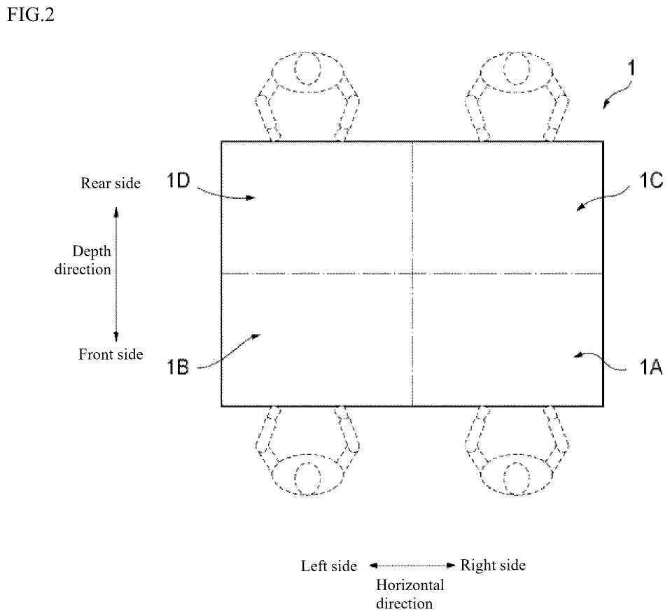

First, with reference to FIG. 1 and FIG. 2, an outline of the configuration of a lottery game device 1 according to one or more embodiments and a lottery game performed by the lottery game device 1 will be described. FIG. 1 is a perspective view illustrating a configuration of the lottery game device 1. FIG. 2 is a schematic diagram illustrating the lottery game device 1 in use.

The lottery game device 1 according to one or more embodiments is an example of a game device in which a plurality of players can simultaneously play their own lottery games. Here, the lottery game, for example, includes a Corinth game played in a first lottery game unit 10 described later, and a Pusher game played in a second lottery game unit 20 described later. The Corinth game is played using a ball, which is an example of a play medium for the Corinth game. Note that the play medium for the Corinth game may be something other than a ball, such as a medal or a cube or the like, and may include two or more types of play mediums. The Pusher game includes a Ball Pusher game played using a ball and a Medal Pusher game played using medals. The Ball Pusher game and the Medal Pusher game are played simultaneously. The Corinth game can be played simultaneously with the Pusher game.

The lottery game device 1 is a lottery device for four players. As illustrated in FIG. 2, the lottery game device 1 includes game devices 1A to 1D. Each of the game devices 1A to 1D has the same configuration. Therefore, by changing the number of game devices constituting the lottery game device 1, the number of players who can utilize the lottery game device 1 can be changed to numbers other than just one or four. In the following description, the configuration of a game device 1A will be mainly described.

### <Details of Game Device 1A>

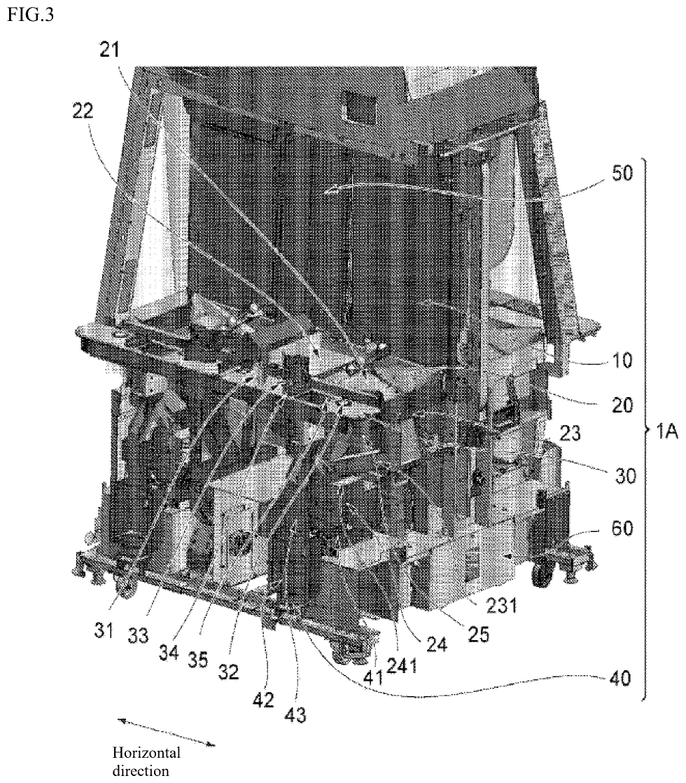

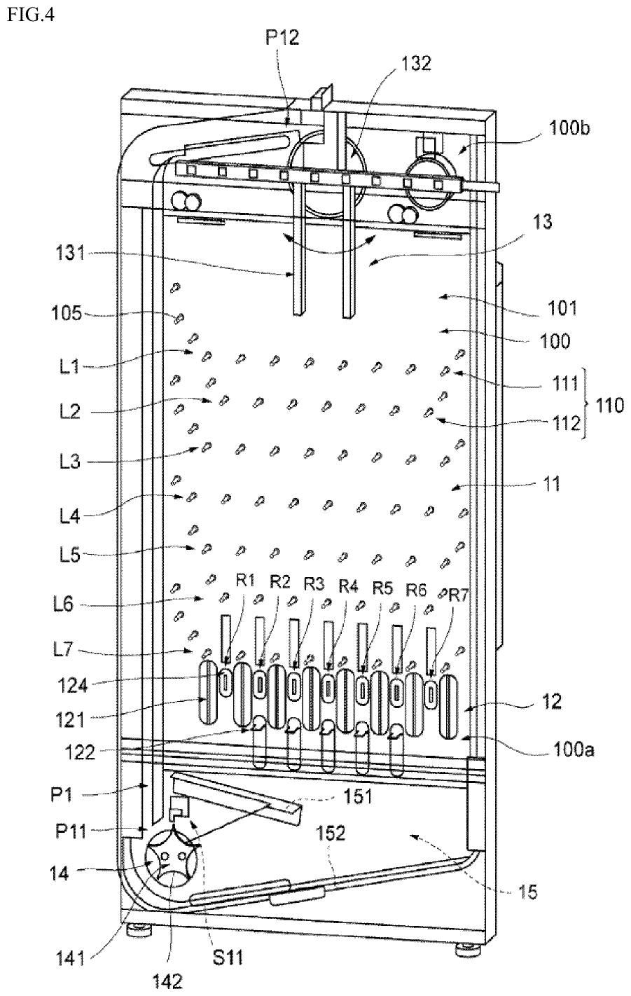

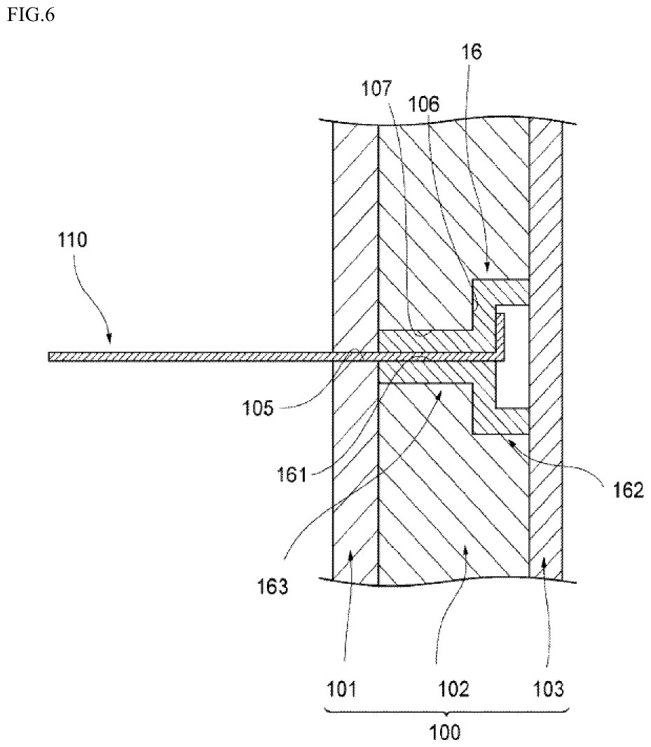

Next, important components of the game device 1A according to one or more embodiments will be described in detail with reference to FIG. 1 to FIG. 9. FIG. 3 is a perspective view illustrating the internal structure of the lottery game device. FIG. 4 through FIG. 6 are diagrams illustrating the configuration of the first lottery game unit 10. FIG. 6 through FIG. 9 are diagrams illustrating the configuration of the second lottery game unit 20.

As illustrated in FIG. 1 and FIG. 3, the game device 1A comprises: a first lottery game unit 10 for playing the Corinth game; a second lottery game unit 20 for playing the Pusher game; an operation unit 30 that receives operations from the player; a payout part (or payout unit) 40 that pays out play result mediums such as medals corresponding to the results of the lottery game to the player; a screen display 50 that displays information relating to the lottery game; a control unit (or controller) 60 that may comprise a central processing unit (CPU), a random access memory (RAM), and read only memory (ROM), and executes the lottery game by controlling the operation of each of the first lottery game unit 10, the second lottery game unit 20, the operation unit 30, the payout part 40, and the screen display 50; and a housing 70 that supports or houses the abovementioned configuration.

As illustrated in FIG. 3, the first lottery game unit 10 and the screen display 50 are disposed on the upper rear side of the second lottery game unit 20 and perpendicular to the upper surface of the second lottery game unit 20. Note that the first lottery game unit 10 and the screen display 50 may be disposed at an angle or horizontally relative to the upper surface of the second lottery game unit 20. The operation unit 30 and the payout part 40 are attached to the housing 70. The screen display 50 is disposed inside the housing 70.

### [First Lottery Game Unit 10]

Next, the configuration of the first lottery game unit 10 will be described with reference to FIG.

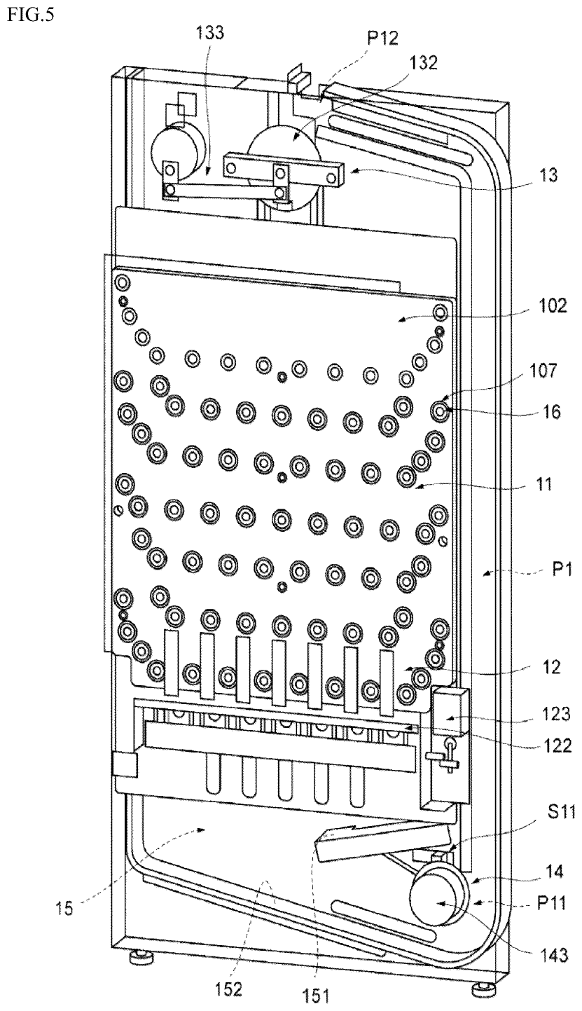

4 to FIG. 6. As illustrated in FIG. 4 and FIG. 5, the first lottery game unit 10 includes a play board 11 having a base part (or base) 100 and a plurality of guide pins 110 attached to the base part 100, a reception part (or medium reception unit) 12 disposed on a first end 100a side of the base part 100, an input part (or medium throwing unit) 13 disposed on a second end 100b side of the base part 100 for inputting balls toward the plurality of guide pins 110 such that the balls will reach the reception part 12, a conveyor part 14 for conveying balls to the input part 13, and a housing portion 15 for storing balls that will be dropped from the reception part 12.

### (Base Part 100)

As illustrated in FIG. 4 to FIG. 6, the base part 100 has a decorative plate 101 on which information about the Corinth game is printed, an attachment plate 102 for attaching a guide pin 110 disposed on the back surface of the decorative plate 101, and a cover 103 for fixing the guide pin 110 attached to the attachment plate 102. The decorative plate 101 comprises a plurality of holes 105 for passing the guide pins 110 therethrough, and the attachment plate 102 comprises a plurality of holes 107 for attaching the guide pins 110 therethrough. As illustrated in FIG. 6, the hole 107 has a step part 106.

### (Guide Pin 110)

The guide pin 110 is a component for changing the aspect in which the ball, which is an example of a play medium, moves while the ball is bounced (or hits and rebounds from at least one of the guide pins 110) when the ball comes into contact with the guide pin 110. The guide pin 110 is made of, for example, a metal material. As illustrated in FIG. 6, the guide pin 110 is attached to the base part 100 via an attachment part (or attachment fixture) 16 without being in direct contact with the base part 100.

Here, the attachment part 16 is made of a material, such as resin or the like, that has a lower hardness than the guide pin 110. By using this type of attachment part 16, it is possible to absorb vibrations of the guide pin 110 compared to attaching the guide pin 110 directly to the base part 100, and by using a material that is less hard than the material of the base part 100, it is possible to reduce the risk of the attachment part 16 vibrating and wearing down the base part 100. As a result, the orientation and attaching precision of the guide pin 110 relative to the base part 100 can be easily maintained.

The attachment part 16 has a retaining hole 161, a large diameter part 162, and a small diameter part 163. The guide pin 110 is attached to the retaining hole 161 and thereby fixed integrally with the attachment part 16. The position of the integrated guide pin 110 and attachment part 16 relative to the base part 100 is fixed, with the large diameter part 162 being sandwiched between the step part 106 of the hole 107 of the attachment plate 102 and the cover 103. In this way, vibrations of the guide pin 110 can be absorbed, and the orientation and attaching precision of the guide pin 110 relative to the base part 100 can be easily maintained.

As illustrated in FIG. 4, the guide pins 110 are disposed on the base part 100 in a plurality of rows along the longitudinal direction of the base part 100. In the example illustrated in FIG. 4, the plurality of rows is seven rows, from a first row L1 to a seventh row L7. Moreover, the longitudinal direction of the base part 100 is an example of a predetermined direction of the base part 100. The predetermined direction may be a direction other than the longitudinal direction depending on the arrangement of the base part 100 and the change in the shape of the base part 100.

The plurality of guide pins 110 are configured such that the elasticity of at least one guide pin will be different from the elasticity of the other guide pins, and/or at least one inter-row distance between the rows will be different from the other inter-row distances to change and adjust the movement of the balls. Here, the greater the elasticity of the guide pin, the greater the force (bouncing force) applied to the balls that come into contact with the guide pin. As a result, the balls will bounce a long distance. On the other hand, when the elasticity of the guide pin is small, the force (bouncing force) applied to the balls that come in contact with the guide pin is small. As a result, the balls will bounce a short distance. Moreover, the greater the distance between the rows, the less restriction there is on the ball bouncing range. As a result, the balls will bounce a long distance. On the other hand, when the distance between the rows is small, there is a more restriction on the ball bouncing range. As a result, the balls will bounce a short distance.

Here, the elasticity of the guide pin 110 can be made different by various methods. For example, the guide pins 110 may be configured to have different diameters (that is, thicknesses). In this case, the larger the diameter, the less elastic the guide pins 110 become. In addition, for example, the guide pins 110 may be configured such that the material of each the guide pins 110 are different. In this case, the greater the elasticity of the material that composes the guide pin 110, the greater the elasticity of the guide pin 110. Also, for example, the length of the portion of the guide pin 110 that protrudes from the base part 100, that is, the length of the portion that is actually used during the game, may be configured to be different. In this case, the longer the length of the actually used portion of the guide pin 110, the more likely the guide pin 110 is to bend due to impact from the ball when it comes into contact with the ball, and the smaller the elasticity of the guide pin 110 will become. Additionally, the guide pin 110 may be configured using a combination of some or all of these methods.

For example, the plurality of guide pins 110 include at least two types of guide pins: first guide pins 111 having a first elasticity and second guide pins 112 having a second elasticity larger than the first elasticity. Of the plurality of rows, the second guide pins 112 are arranged closer to the first end 100a side of the base part 100 than the first guide pins 111. Additionally, of the plurality of rows, the number of rows defined by the second guide pins may be greater than the number of rows defined by the first guide pins.

In the example illustrated in FIG. 4, the first guide pins 111 form a first row L1 closest to the input part 13, and the second guide pins 112 form a second rows L2 to a seventh row L7. In this way, the player can easily insert balls into the row between the guide pins 110 that is being aimed at.

Additionally, for example, of the plurality of inter-row distances formed by a plurality of rows, at least one inter-row distance is formed to be larger than the other inter-row distances. Furthermore, the distance between at least one of the rows may be formed closer to the first end 100a side than the second row L2, which is closer to the second end 100b side of the base part 100.

In the example illustrated in FIG. 4, the line distance between the first row L1 and the second row L2 is D1, and the line distance between each of the second row L2 to the seventh row L7 is D2. Furthermore, the row distance D1 is smaller than the row distance D2. That is, among the plurality of inter-row distances formed by the plurality of rows, the inter-row distance closest to the input part 13 is the smallest. In this way, by moving closer to the reception part 12, the bouncing range of the ball can be increased, the falling time of the ball can be extended, and the anticipation of the player with respect to the lottery game can be increased.

### (Input Part 13)

The input part 13 is configured for balls to be input toward the plurality of guide pins 110 such that the balls will reach the reception part 12. As illustrated in FIG. 4 and FIG. 5, the input part 13 has a tip part 131, a base part (or base) 132 to which the tip part 131 is attached, and a driving unit 133 for transmitting a driving force to the base part 132 to rotate the base part 132 back and forth in the direction illustrated in FIG. 4. The tip part 131 can rotate to input balls into each column of the guide pins 110 in the first row L1.

Furthermore, if the shortest distance between the tip part 131 and first row L1 is “1” and the diameter of the ball is “d”, then “d” and “1” have the relationship d<l≤2d. With the input part 13 positioned in this manner, the bouncing of the balls immediately after they are input from the input part 13 can be suppressed, making it easier to input balls into the rows between the target guide pins 110.

### (Conveyor Part 14)

The conveyor part 14 is configured to convey the balls one by one to the input part 13 via the conveyance path P1. As illustrated in FIG. 4, the conveyor part 14 has a conveying plate 141 and a driving unit 143 that drives the rotation of the conveying plate 141. The conveying plate 141 comprises five recesses 142. The recesses 142 have a shape that correspond to the outer shape of the balls. Here, the conveyance path P1 has an upstream inlet P11 connected to the housing portion 15 and a downstream outlet P12 connected to the input part 13.

The driving unit 143 operates under the control of the control unit 60 to rotate the conveying plate 141. An inlet sensor S11 is disposed above the conveying plate 141 to detect whether the conveying plate 141 is rotating. For example, when the conveying plate 141 does not rotate due to damage or clogging of the conveying plate 141, the inlet sensor S11 can detect this information and transmit it to the control unit 60. In addition, when the entire conveyance path P1 is clogged with balls, the conveying plate 141 conveys the balls further into the conveyance path P1, allowing for the ball located closest to outlet P12 on conveyance path P1 to be pushed out to input part 13.

### (Reception Part 12)

The reception part 12 is an example of a trigger that causes the lottery game to proceed by detecting balls. As illustrated in FIG. 4 and FIG. 5, the reception part 12 is disposed below the plurality of guide pins 110 and above the housing portion 15. Depending on the configuration of the plurality of guide pins 110, the reception part 12 may be disposed within the area of the base part 100 in which the plurality of guide pins 110 are disposed, or may be disposed above the plurality of guide pins 110. The reception part 12 has a guide plate 121 that defines seven columns R1 to R7, a ball support portion 122 that is movable up and down and is disposed below columns R2 to R6, a ball sensor 124 that can detect the presence or absence of balls in each of columns R1 to R7 or the passage of balls, and a driving unit 123 that drives the up and down movement of the ball support portion 122.

Each of the columns R1 to R7 is disposed at a position corresponding in the up-down direction to each of the columns formed by the first guide pins 111 in the first row L1. When a lottery for the Corinth game is held, the ball support portion 122 is first positioned at the outlet of column R2 to column R6. When balls input through the input part 13 enter the column R1 and the column R7, the balls pass through the column R1 and the column R7 and fall into the housing portion 15. On the other hand, when balls input by the input part 13 enter the column R2 to column R6, the balls are supported by the ball support portion 122 such that they will be positioned within column R2 to column R6.

Each of the plurality of ball sensors 124 can detect ball information of the balls received in each of columns R1 to R7, for example, the presence or absence of balls that have passed through columns R1 and R7, the presence or absence of balls stored in each of columns R2 to R6, the number and type of balls stored in each of columns R2 to R6, etc. In addition, when each of the plurality of ball sensors 124 detects ball information, it transmits the detected ball information to the control unit 60, and under the control of the control unit 60, the ball support portion 122 that is vertically movable and the lottery (physical lottery and program above) or other components of the game device 1A (for example, the second lottery game unit 20) can be operated.

The ball support portion 122, which is vertically movable, moves in the vertical direction under the control of the control unit 60 to open and close the outlets of columns R2 to R6. Specifically, the control unit 60 can initiate the downward movement of the ball support portion 122 based on the ball information in columns R1 to R7 from the plurality of ball sensors 124. Here, for example, when a first ball enters any of the columns R2 to R6 and another ball is detected by each of the plurality of ball sensors 124 to have subsequently passed through the same columns, resulting in two balls overlapping in some or all of the columns R2 to R6, the control unit 60 determines whether two balls overlap while the ball sensors 124 continue to detect for balls and detect whether balls have entered the same column as previous balls during the same game. If these determination results are “YES”, the control unit 60 can move the ball support portion 122 downward such that the ball stored in the field falls into the housing portion 15.

### (Housing Portion 15)

As illustrated in FIG. 4 and FIG. 5, the housing portion 15 has a first guide plate 151 and a second guide plate 152. The first guide plate 151 is disposed above the conveyor part 14. In this way, the first guide plate 151 can guide the balls that fall from the columns R1 to R3 to the second guide plate 152 such that the balls do not collide directly with the conveying plate 141 of the conveyor part 14. The second guide plate 152 is disposed at an incline so as to guide the balls that have fallen into the housing portion 15 to the conveyor part 14.

### [Second Lottery Game Unit 20]

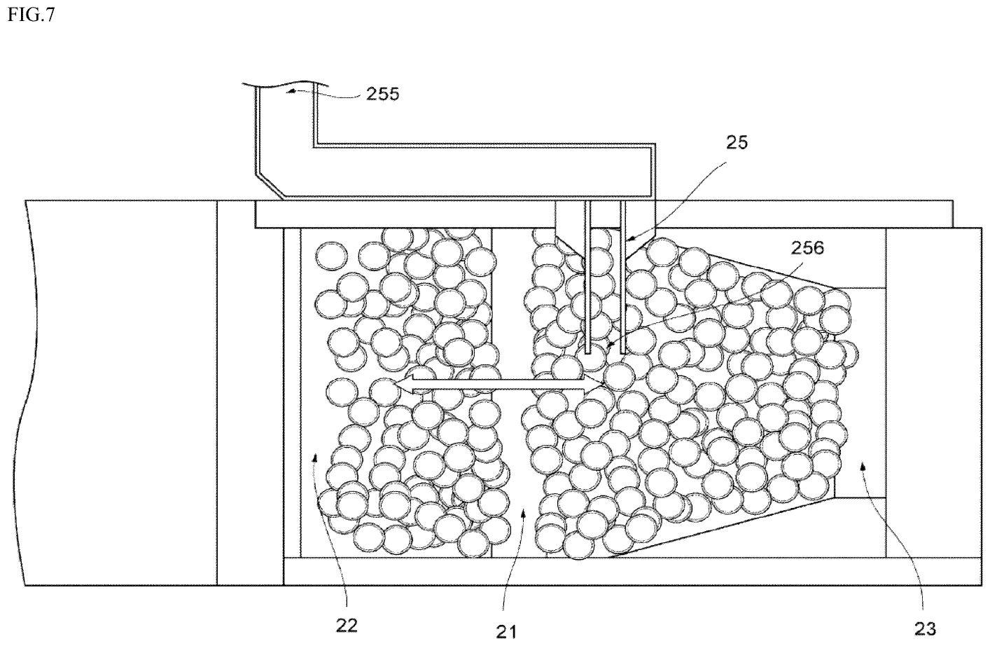

Next, the configuration of the second lottery game unit 20 will be described with reference to FIG. 3 and FIG. 7 to FIG. 9. As illustrated in FIG. 3 and FIG. 7, the second lottery game unit 20 includes a placement surface 21 on which medals and balls are placed, a pusher table 22 that moves the medals and balls placed on the placement surface 21, a drop port 23 through which the medals and balls that are placed on the placement surface 21 will drop, a medal supplying part 24 that supplies the medals to the placement surface 21, and a ball supplying part 25 that supplies the balls to the placement surface 21.

### (Placement Surface 21)

The placement surface 21 is configured to be used for the Pusher game. As illustrated in FIG. 3, the placement surface 21 is disposed such that its longitudinal direction coincides with the width direction of the game device 1A. Furthermore, the placement surface 21 allows for medals supplied by the medal supplying part 24 and balls supplied by the ball supplying part 25 to be placed thereon.

### (Pusher Table 22)

The pusher table 22 is configured to be used in the Medal Pusher game and the Ball Pusher game. The pusher table 22 is disposed above the placement surface 21 and at one end side of the placement surface 21 in the longitudinal direction. Furthermore, under the control of the control unit 60, the pusher table 22 can move horizontally back and forth in the direction along the longitudinal direction of the placement surface 21 as indicated by the arrow in FIG. 7.

### (Drop Port 23)

The drop port 23 is configured to be used for the Pusher game. The drop port 23 is disposed on the other end side of the placement surface 21 in the longitudinal direction. The medals and balls pushed by the pusher table 22 can fall from the placement surface 21 through the drop port 23. The drop port 23 has a collection path 231 that guides the movement of the dropped medals and balls. The collection path 231 is connected to the medal supplying part 24 and the ball supplying part 25.

### (Medal Supplying Part 24)

The medal supplying part 24 is configured to supply medals for the Medal Pusher game to the placement surface 21. As illustrated in FIG. 3, the medal supplying part 24 has a medal housing portion 241 and a conveyor part 242 that conveys the medals in the medal housing portion 241 to the placement surface 21. The medals dropped from the drop port 23 are conveyed to the medal housing portion 241 via a collection path 231.

### (Ball Supplying Part 25)

The ball supplying part 25 is configured to supply balls for the Ball Pusher game to the placement surface 21. As illustrated in FIG. 3 and FIG. 7 to FIG. 9, the ball supplying part 25 has a spiral conveying lift 251 and a guiding part 252, which guides balls conveyed from the conveying lift 251 to a position on the placement surface 21 where the ball does not interfere with the moving range of the pusher table 22.

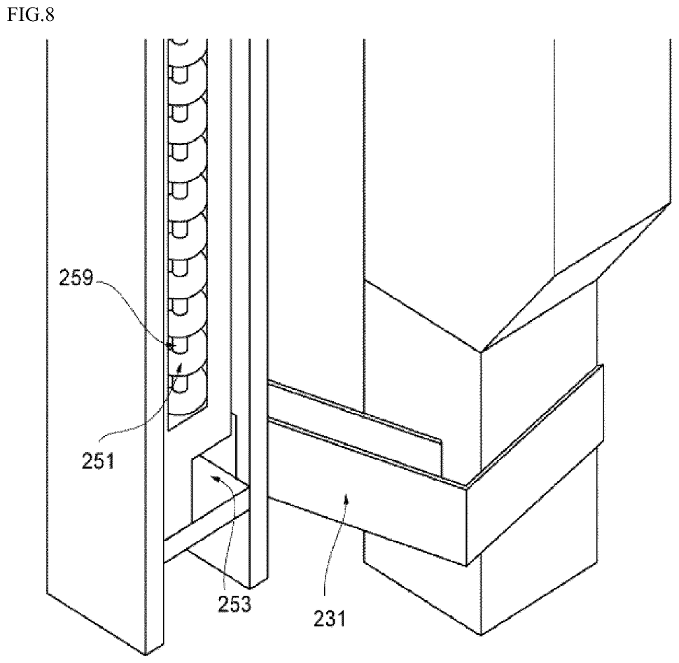

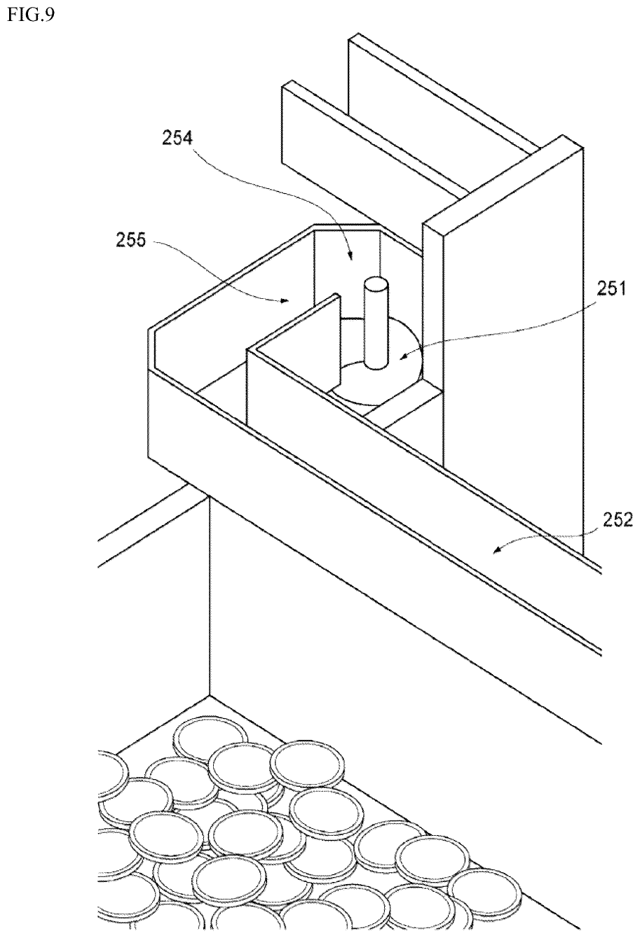

As illustrated in FIG. 8 and FIG. 9, the conveying lift 251 has a conveyance inlet 253 on its lower side and a conveyance outlet 254 on its upper side. The conveying lift 251 can convey balls at the conveyance inlet 253 to the conveyance outlet 254 by rotating around a central axis 259. In addition, the conveyance inlet 253 is directly connected to the collection path 231. Therefore, the balls that drop from the drop port 23 are conveyed via the collection path 231 directly to the conveyance inlet 253 located below the conveying lift 251, and then conveyed directly to the conveyance inlet 253 by the conveying lift 251.

As illustrated in FIG. 7 and FIG. 9, the guiding part 252 has one end 255 and another end 256. One end 255 is connected to the conveyance inlet 253. The other end 256 is disposed above the placement surface 21 such that the balls can fall at a position on the placement surface 21 that does not interfere with the moving range of the pusher table 22. In this way, the balls conveyed from the conveyance inlet 253 enter one end 255 and then can be supplied to the placement surface 21 from the other end 256 without colliding with the upper surface of the pusher table 22.

### [Operation Unit 30]

The operation unit 30 is configured to receive various operations from the player. As illustrated in FIG. 3, the operation unit 30 includes a first operation unit 31 that controls the rotation direction of the input part 13, a second operation unit 32 that inputs balls into the play board 11 using the input part 13, a second operation unit 33 that pays out medals corresponding to the result of the lottery game, a starting medium reception part (or starting medium reception part unit) 34 that receives medals, which are an example of a play starting medium, from the player for starting the lottery game, and a money bowl 35 on which the player places medals and the like retained by the player.

### [Payout Part 40]

The payout part 40 is configured to pay out medals, which are an example of a play result medium, to the player, corresponding to the result of the lottery game played by the player. As illustrated in FIG. 3, the payout part 40 includes a housing portion 41 for storing medals inserted by a player and medals to be paid out to a player, a payout outlet 42, and a conveyor part 43 for transporting the medals stored in the housing portion 41 to the payout outlet 42.

Here, the medals circulating between the starting medium reception part 34 and the payout part 40 as well as the medals used in the Medal Pusher game described above are in different circulation systems. In other words, the medals used in the Pusher game are not paid out to the player. In addition, the circulation systems for the balls used in the Corinth game and the balls used in the Ball Pusher game are independent of each other.

### [Screen Display 50]

The screen display 50 is configured to display various game contents and game information relating to the lottery game. The game content of one or more embodiments includes the display of a portion of the Medal Pusher game, and the game information of one or more embodiments includes, for example, the number of medals inserted by the player into the starting medium reception part 34 and any changes in that number as well as information on the number of medals paid out.

### [Control by the Control Unit 60]

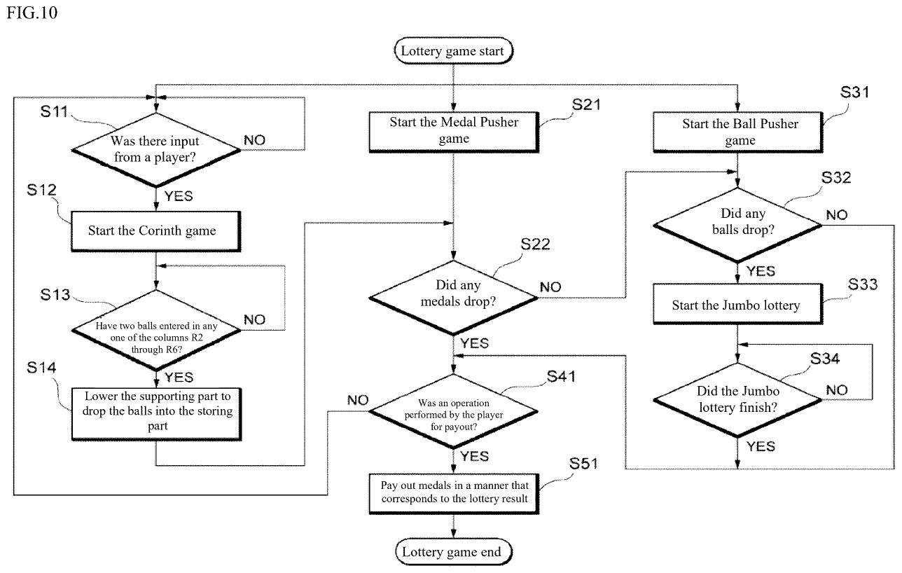

Next, with reference to FIG. 10, a detailed description will be given of an example of control by the control unit 60, that is, a process related to the lottery game performed by the control unit 60 based on the data and programs or instructions stored in the memory. Depending on the settings, the control unit 60 can perform processes relating to different lottery games. FIG. 10 is a flowchart for explaining the control of the lottery game by the control unit 60.

### (Steps S11, S21, S31)

First, the control unit 60 starts the Medal Pusher game and the Ball Pusher game via the second lottery game unit 20 (steps S21, S31), and determines whether there is an input from the player to start the Corinth game (Step S11).

### (Steps S13, S14, S22)

When there is an input from the player to start the Corinth game (YES in step S11), the control unit 60 starts the Corinth game via the first lottery game unit 10 (step S12). Next, the control unit 60 determines whether two balls have entered any one of the columns R2 to R6 of the reception part 12 of the first lottery game unit 10 (step S13). When two balls enter any one of the columns R2 to R6 of the reception part 12 (YES in step S13), the control unit 60 lowers the ball support portion 122 to drop the balls into the housing portion 15 (step S14), and then pays out medals to the payout part 40 depending on the ball storage status in each column before the balls were dropped (e.g., the number of balls lined up in each column). Thereafter, the control unit 60 determines whether any medal has fallen into the drop port 23 by being pushed by the pusher table 22 in the Medal Pusher game while it is ongoing (step S22).

Here, in one or more embodiments, the control unit 60 has been described as initiating a physical lottery for the lottery game based on the storage state of the balls actually stored in the reception part 12, but it is not limited to this. For example, the control unit 60 may, alternatively, perform a non-physical lottery (programmed lottery) based on a pre-stored program or instructions, without relying on the storage state of the balls in the reception part 12. In this case, the control unit 60 can, for example, start a lottery in which the number of medals to be paid out varies depending on the column into which the ball falls. Specifically, when balls land in column R4, the control unit 60 can pay out a maximum of 100 medals, whereas when balls land in column R2, the control unit 60 can pay out a maximum of 500 medals. Additionally, the control unit 60 can start a lottery to determine the number of medals to be paid out, for example, on the condition that two balls overlap in any of the columns. Specifically, when three of the columns R2 to R6 have balls in them, the control unit 60 can start a lottery for a maximum of 100 medals, whereas when four of the columns R2 to R6 have balls in them, the control unit 60 can start a lottery for a maximum of 500 medals. (Steps S32 and S33)

If no medals have fallen into the drop port 23 (NO in step S22), the control unit 60 determines whether any balls have fallen into the drop port 23 as a result of being pressed by the pusher table 22 in the ongoing Ball Pusher game (step S32). If there are any dropped balls in the drop port 23 (YES in step S32), the control unit 60 starts a jumbo lottery (step S33).

Here, the jumbo lottery performed in step S33 is the same lottery game as the Corinth game performed in steps S11 to S14, but the only difference is the number of medals to be paid out corresponding to the lottery result. For this reason, a detailed explanation of the jumbo lottery will be omitted. Alternatively, the jumbo lottery may be a lottery game other than the Corinth game. (Steps S34, S41, S51)

Next, the control unit 60 determines whether the jumbo lottery has ended (step S34). When the jumbo lottery has ended (YES in step S34), the control unit 60 determines whether the player has performed an operation to pay out medals (step S41). When an operation to pay out medals is performed by the player (YES in step S41), the control unit 60 pays out to the payout outlet 42 a number of medals corresponding to both the lottery result of the Corinth game and the ball lottery result of the Ball Pusher game, that is, the lottery result of the jumbo lottery (step S51), after which the lottery game will end.

On the other hand, if there is no input from the player to start the Corinth game (NO in step S11), the control unit 60 returns the process to step S11. If two balls are not in any one of the columns R2 to R6 of the reception part 12 (NO in step S13), the control unit 60 returns the process to step S13.

On the other hand, if there are medals dropped into the drop port 23 (YES in step S22), the control unit 60 advances the process to step S41, and determines whether the player has performed an operation to pay out medals (step S41). In this case, when an operation to pay out medals is performed by the player (YES in step S41), the control unit 60 pays out to the payout outlet 42 a number of medals corresponding to the lottery result of the Corinth game and the lottery result of the medal lottery and/or the ball lottery result of the Ball Pusher game (step S51), after which the lottery game will end.

On the other hand, if no balls have fallen into the drop port 23 (NO in step S32), the control unit 60 advances the process to step S41, and determines whether the player has performed an operation to pay out medals (step S41). In this case, when an operation to pay out medals is performed by the player (YES in step S41), the control unit 60 pays out to the payout outlet 42 a number of medals corresponding to the lottery result of the Corinth game and the lottery result of the medal lottery (step S51), after which the lottery game will end.

On the other hand, if there is no operation to pay out medals from the player (NO in step S41), the control unit 60 returns the process to step S11. That is, if there is no operation for paying out medals from the player, the control unit 60 can repeatedly perform the Corinth game, the Medal Pusher game, and the Ball Pusher game.

The first lottery game unit 10 according to the embodiments described above comprises a play board 11 having a base part 100 and a plurality of guide pins 110 which are disposed on the base part 100 in a plurality of rows along the longitudinal direction, which is an example of a predetermined direction of the base part 100, and which change the aspect of movement of a ball by bouncing the ball upon contact with the ball, which is an example of a play medium, a reception part 12 disposed on a first end 100a side of the longitudinal direction of the base part 100, and an input part 13 which is disposed on a second end 100b side opposite to the first end 100a of the base part 100, and which inputs balls towards the plurality of guide pins 110 such that the balls will reach the reception part 12, and the plurality of guide pins 110 are configured such that the elasticity of at least one guide pin is different from the elasticity of the other guide pins and/or the inter-row distance of at least one of the plurality of rows is different from the inter-row distances of the other rows. As a result, by using a simple configuration, it is possible to diversify the falling aspect of the ball, which is an example of a play medium related to the Corinth game, and thereby extend the duration of the fall.

Furthermore, in the first lottery game unit 10 according to the embodiments described above, the plurality of guide pins 110 include at least a first guide pin 111 having a first elasticity and a second guide pin 112 having a second elasticity greater than the first elasticity, and the second guide pin 112 can be positioned longitudinally closer to the first end 100a side than some or all of the first guide pins 111. As a result, by increasing the elasticity of the guide pin 110 that comes into contact with the ball relatively early and decreasing the elasticity of the guide pin 110 that comes into contact with the ball relatively late, the range of movement of the ball at the beginning of its fall can be restricted more than the range of movement of the ball thereafter.

In addition, in the first lottery game unit 10 according to the embodiments described above, among the plurality of rows, at least the first row L1 closest to the input part 13 in the longitudinal direction can be formed by the first guide pin 111. As a result, the player can easily insert balls into the row of the first guide pin 111 that is being aimed at.

Furthermore, in the first lottery game unit 10 of the embodiments described above, if the maximum diameter of the ball is d and the shortest distance between the input part 13 and the first row L1 is 1, d and l can have the relationship d<l≤2d. As a result, with the input part 13 positioned in this manner, the bouncing of the balls immediately after they are input from the input part 13 can be suppressed, making it easier to input balls into the rows between the target guide pins 110.

Furthermore, in the first lottery game unit 10 according to the embodiments described above, the number of rows formed by the second guide pins 112 among the plurality of rows can be greater than the number of rows formed by the first guide pins 111. As a result, by making the number of second guide pins 112 having greater elasticity greater than the number of first guide pins 111 having less elasticity, the falling time of the ball can be reliably extended.

In addition, in the first lottery game unit 10 according to the embodiments described above, among the plurality of inter-row distances formed by the plurality of rows, at least one inter-row distance D1 can be formed to be larger than the other inter-row distances D2. As a result, by adjusting the distance between the rows, the range over which the ball can bounce can be adjusted.

Furthermore, in the first lottery game unit 10 according to the embodiments described above, at least one inter-row distance can be formed closer to the first end 100a side than the second row L2 which is closer to the second end side in the longitudinal direction. As a result, by moving closer to the reception part 12, the bouncing range of the ball can be increased, the falling time of the ball can be extended, and the anticipation of the player with respect to the lottery game can be increased.

Additionally, in the first lottery game unit 10 according to the embodiments described above, each of the plurality of guide pins 110 is disposed on the base part 100 via an attachment part 16, and the attachment part 16 may be made of a material having a lower hardness than each of the plurality of guide pins 110 and be configured such that each of the plurality of guide pins 110 do not come into direct contact with the base part 100. As a result, vibrations of the guide pin 110 can be absorbed, and the orientation of the guide pin 110 relative to the base part 100 can be easily maintained.

In addition, the lottery game device 1 according to the embodiments described above includes a first lottery game unit 10 for playing any one of the Corinth games described above, a second lottery game unit 20 for playing the Pusher game using medals and balls, a starting medium reception part 34 for receiving medals which are an example of a play medium through operation by a player, a payout part 40 for paying out medals which are an example of a play result medium to the player, and a control unit 60 configured such that medals which are a play result medium corresponding to one result will be paid out to the payout part 40 based on any one of the lottery result of the Corinth game by the first lottery game unit 10 started by the starting medium reception part 34 receiving the medals, the medal lottery result of the Medal Pusher game by the second lottery game unit 20, and the lottery result of the Corinth game by the first lottery game unit 10 started based on the ball lottery result of the Ball Pusher game by the second lottery game unit 20, whereby the Pusher game can be played at the same time as the Corinth game, and the falling aspect of the balls in the Corinth game can be diversified and the falling time can be extended, and the association between the two games can increase players' anticipation with respect to the lottery and the players' amusement with respect to the lottery game.

The present invention is not limited to the embodiments described above, and as long as the features of the invention are included, the scope of the invention also includes design changes that a person skilled in the art could make to these embodiments as appropriate. For example, game machines other than Corinth games, smart ball cabinets, and other game devices that use guide pins, play boards, and play mediums are included within the scope of the present invention. In other words, each of the elements of the embodiments described above and their arrangement, materials, conditions, shapes, sizes, and the like are not limited to those exemplified, and can be modified as appropriate. Furthermore, the elements of each of the above-described embodiments can be combined to the extent technically possible, and such combinations are also included within the scope of the present invention as long as they include the features of the present invention.

### DESCRIPTION OF REFERENCE NUMERALS

10 . . . First lottery game unit
11 . . . Play board
12 . . . Reception part
13 . . . Input part
16 . . . Attachment part
20 . . . Second lottery game unit
34 . . . Starting medium reception part
40 . . . Payout part
100 . . . Base part
110 . . . Guide pin
111 . . . First guide pin
112 . . . Second guide pin

What is claimed is:

1. A game device, comprising:
a play board that comprises:
a base; and
guide pins disposed on the base in rows along a predetermined direction of the base, wherein
a play medium may hit and rebound from at least one of the guide pins to change a movement direction;
a medium reception unit that is disposed on the base and configured to receive the play medium rebounded from the at least one of guide pins; and
a medium throwing unit that throws the play medium toward the guide pins such that the play medium reaches the medium reception unit, wherein the guide pins are configured to meet at least one of conditions that:
at least one of the guide pins has elasticity different from elasticity of another of the guide pins; and
at least one inter-row distance between the rows is different from another inter-row distance.

2. The game device according to claim 1, wherein
the guide pins include:
a first guide pin having a first elasticity; and
a second guide pin having a second elasticity greater than the first elasticity, and
the second guide pin is disposed closer to a first end side of the base than some or all of the first guide pins in the predetermined direction.

3. The game device according to claim 2, wherein
among the rows, a first row closest to the medium throwing unit in the predetermined direction is constituted by the first guide pin.

4. The game device according to claim 3, wherein
the medium throwing unit has a relationship with the play medium that:
d<l≤2d, where
d denotes a maximum diameter of the play medium, and l denotes a shortest distance between the medium throwing unit and the first row.

5. The game device according to claim 3, wherein
among the rows, a number of rows formed by the second guide pin is greater than a number of rows formed by the first guide pin.

6. The game device according to claim 1, wherein
among inter-row distances each between the rows, at least one inter-row distance is larger than another of the inter-row distances.

7. The game device according to claim 6, wherein
the at least one inter-row distance is closer to a first end side of the base than a second row disposed close to a second end side of the base in the predetermined direction.

8. The game device according to claim 1, wherein
each of the guide pins is attached to the base via an attachment fixture; and
the attachment fixture is made of a material having a lower hardness than each of the guide pins, and prevent each of the guide pins from directly contacting the base.

9. A lottery game device, comprising:
a first lottery game unit that executes a Corinth game and comprises the game device according to claim 1;
a second lottery game unit that executes a Pusher game using a medal and a ball;
a starting medium reception unit that receives a play starting medium thrown by a player's operation;
a payout unit that pays out a play result medium to a player; and
a controller configured to pay out the play result medium to the payout unit, wherein the play result medium corresponds to one of:
a lottery result of the Corinth game started in response to the starting medium reception unit receiving the play starting medium;
a medal lottery result of the Pusher game; and
a lottery result of the Corinth game started based on a ball lottery result of the Pusher game.
